(19) United States
(12) Patent Application Publication
(10) Pub. No.: US 2007/0101651 A1
(43) Pub. Date: May 10, 2007

(54) Blade of shutter door

(75) Inventor: Ming Nien, Taichung (TW)

Correspondence Address: TROXELL LAW OFFICE PLLC;SUITE 1404, 5205 LEESBURG PIKE, FALLS CHURCH, VA, 22041, US

(73) Assignee: Nien Made Enterprise Co., Ltd.

(21) Appl. No.: 11/269,753

(22) Filed: Nov. 9, 2005

(51) Int. Cl. E06B 7/08

(52) U.S. Cl. 49/92.1

(57) ABSTRACT

The blade of a shutter door includes a blade body and at least one solid member. The blade body is a long and flat hollow shell fixed therein with at least one reinforcing rib between its first and second end and formed with a plurality of hollow spaces separated by the reinforcing ribs. The solid member is stuffed in at least one hollow space at a preset location of the blade body, able to strengthen the structure of the blade and lower material cost.

### BACKGROUND OF THE INVENTION

1. Field of the Invention

This invention relates to the blades of a shutter door, particularly to ones transversely arranged in series and pivotally fixed on the doorframe of a shutter door, able to lower material cost and strengthen the structure of the blades.

2. Description of the Prior Art

A conventional shutter door includes a rectangular doorframe having its inner hollowed space pivotally fixed with lots of blades transversely arranged in series from the upper side to the lower side. Each blade has one broadside connected with an ad justing rod by two U-shaped nails hooked with each other. Thus, the blades of the shutter door can be controlled to be turned open for an angle. The blades of the shutter door are mostly solid bodies made of wood.

However, each solid wooden blade of the conventional shutter door is quite heavy and needs to be made mostly of wood, so each shutter door needs lots of such blades to be disposed thereon, with the cost of material being comparatively high.

### SUMMARY OF THE INVENTION

The objective of the invention is to offer the blade of a shutter door, which includes a blade body and at least one solid member. The blade body is a long and flat hollow shell formed integral of plastic. The hollow shell is fixed therein with at least one reinforcing rib between its first and second- end and formed with a plurality of hollow spaces defined by the reinforcing ribs. The solid member is stuffed in at least one hollow space at a preset location of the blade body for supporting the blade to be turned pivotally or for fixing a U-shaped nail that is connected with an adjusting rod. By so designing, it is possible to strengthen the structure of the blade to prevent it from becoming curved and deformed, and lower material cost.

### BRIEF DESCRIPTION OF DRAWINGS

This invention will be better understood by referring to the accompanying drawings, wherein:

FIG. 1 is a perspective view of a first preferred embodiment of a blade of a shutter door in the present invention;

FIG. 2 is an exploded perspective view of the first preferred embodiment of a blade of a shutter door in the present invention;

FIG. 3 is a perspective view of the first preferred embodiment of the blades assembled on a doorframe in the present invention;

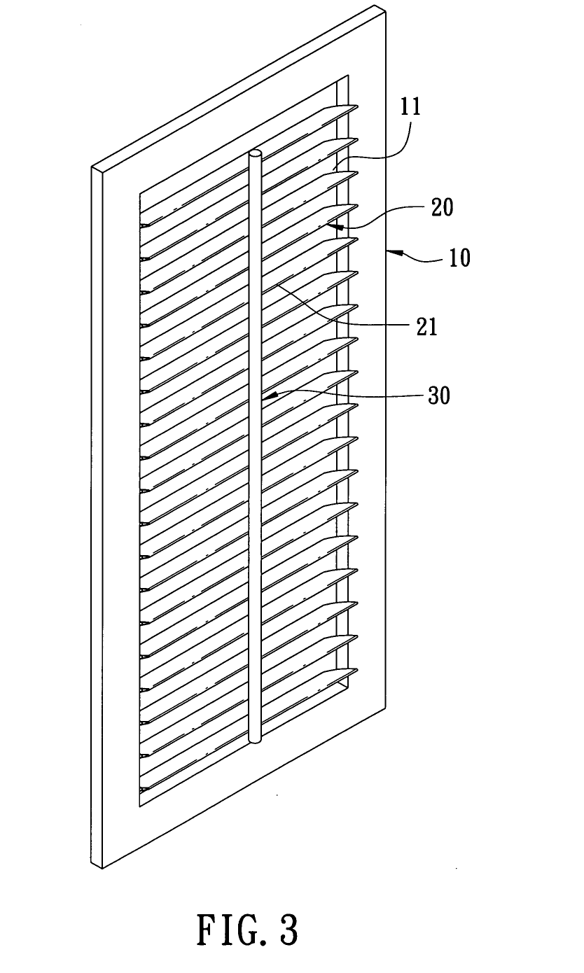

FIG. 4 is a partial perspective view of the first preferred embodiment of the blade having its opposite ends respectively fixed with a pivot in the present invention;

FIG. 5 is a partial perspective view of the first preferred embodiment of the blade connected with an adjusting rod by two U-shaped nails hooked with each other in the present invention;

FIG. 6 is a perspective view of a second preferred embodiment of a blade of a shutter door in the present invention;

FIG. 7 is a perspective view of a third preferred embodiment of the blade of a shutter door in the present invention;

FIG. 8 is a perspective view of a fourth preferred embodiment of the blade of a shutter door in the present invention; and

FIG. 9 is a perspective view of a fifth preferred embodiment of the blade of a shutter door in the present invention.

### DETAILED DESCRIPTION OF THE PREFERRED EMBODIMENT

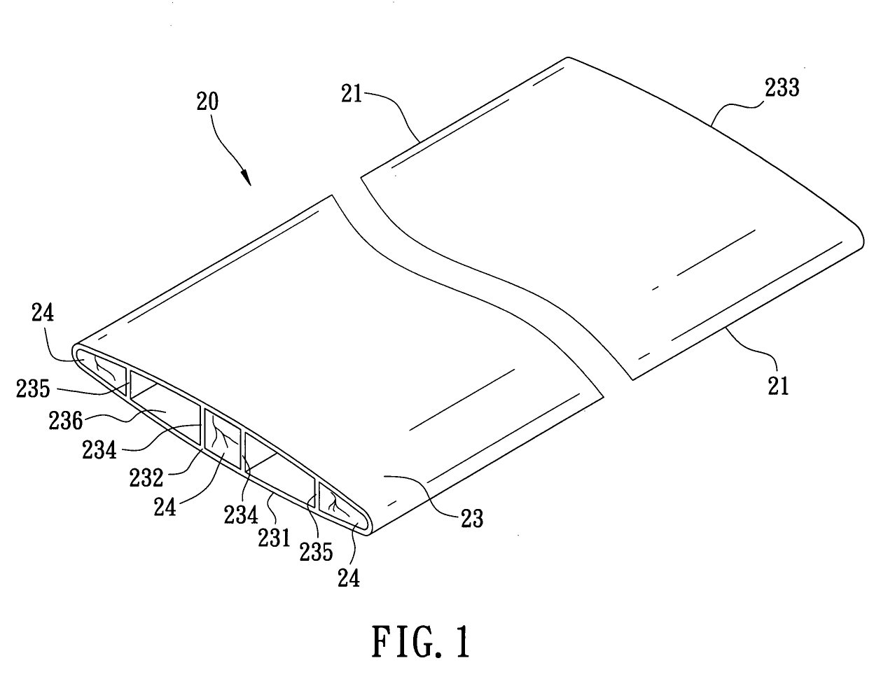

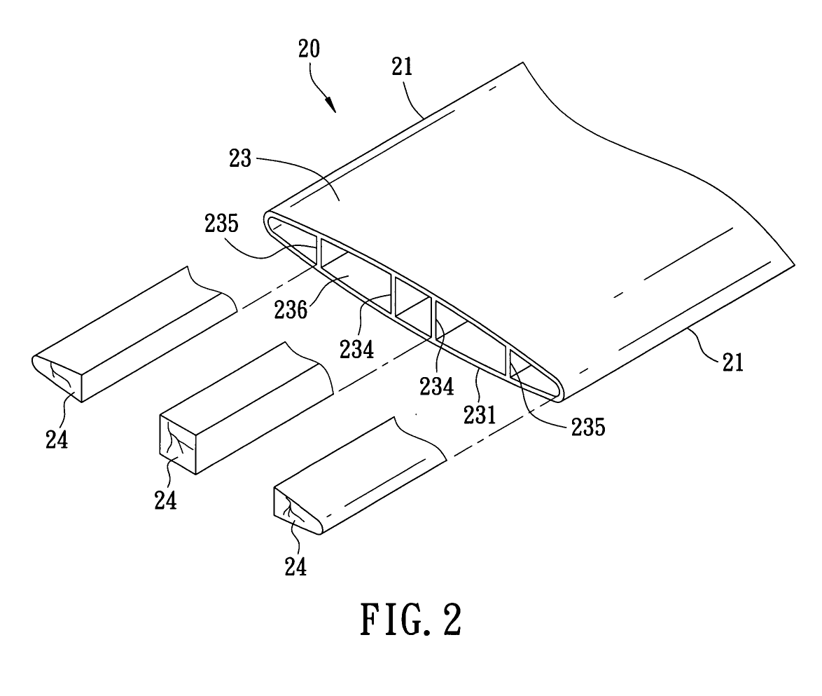

A first preferred embodiment of the blade of a shutter door in the present invention, as shown in FIGS. 1 and 2, includes a rectangular doorframe 10, a plurality of blades 20 and an adjusting rod 30 combined together.

The doorframe 10 has its interior formed with a hollowed space 11 for the blades 20 to be pivotally fixed laterally therein from the upper side to the lower side.

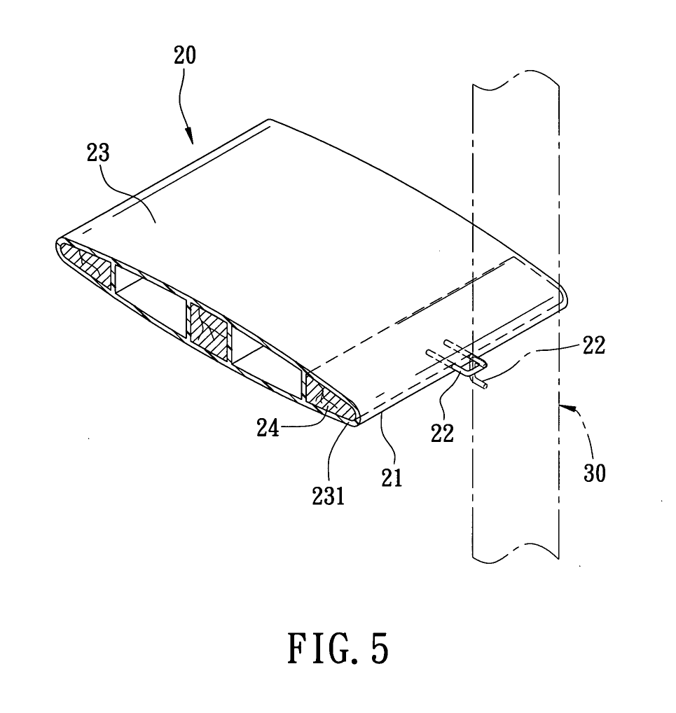

Each blade 20 has its broadside 21 connected with the adjusting rod 30 by means of two U-shaped nails 22 hooked with each other, as shown in FIG. 5, letting the blades 20 controlled by the adjusting rod 30 to be turned pivotally. In addition, each blade 20 consists of a blade body 23 and three solid members 24.

The blade body 23 is shaped as a long and flat hollow shell 23 1 having a first end 232 and a second end 233 opposite to each other. Two reinforcing ribs 234 are lengthwise fixed upright in the intermediate portion of the blade body 23 between the first and the second and 232, 233 of the hollow shell body 231, and other two reinforcing ribs 235 are respectively and lengthwise positioned at a location near the opposite sides of the blade body 23, letting the interior of the hollow shell body 231 formed with five proper-sized hollow spaces 236 separated by the reinforcing ribs 234 and 235.

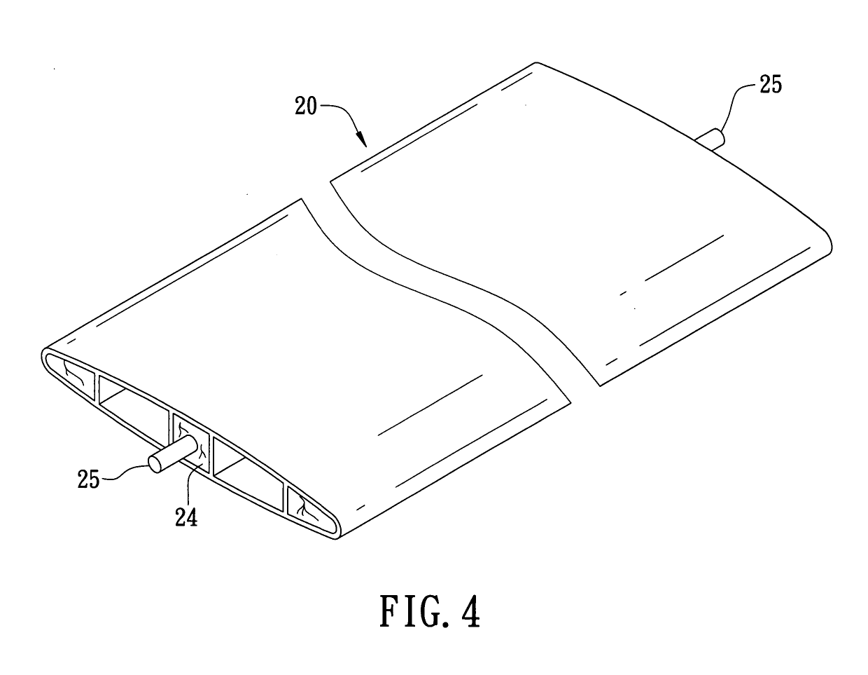

The solid members 24 are made of wood, ABS (acrylonitrile butadiene styrene) or other materials and have their cross sections respectively shaped as the hollow space 236 of the intermediate portion of the hollow shell 231 and the hollow space 236 near the opposite sides of the hollow shell body 231 of the blade body 23 so that the solid member 24 can be respectively and stuffed exactly in the hollow spaces 236. In this preferred embodiment, the length of the solid member 24 is somewhat equivalent to the distance between the opposite ends of the hollow space 236, so the solid member 24 can be fully stuffed in the hollow space 236. In addition, the solid member 24 stuffed in the intermediate hollow space 236 has its opposite ends respectively secured with a pivot 25 to be pivotally connected with the door frame 10, as shown in FIG. 4, while the solid member 24 stuffed in the hollow space 236 at the opposite sides of the hollow shell body 231 is for fixing the U-shaped nail 22 thereon after the U-shaped nail 22 is inserted through the hollow shell 231 of the blade 23, as shown in FIG. 5.

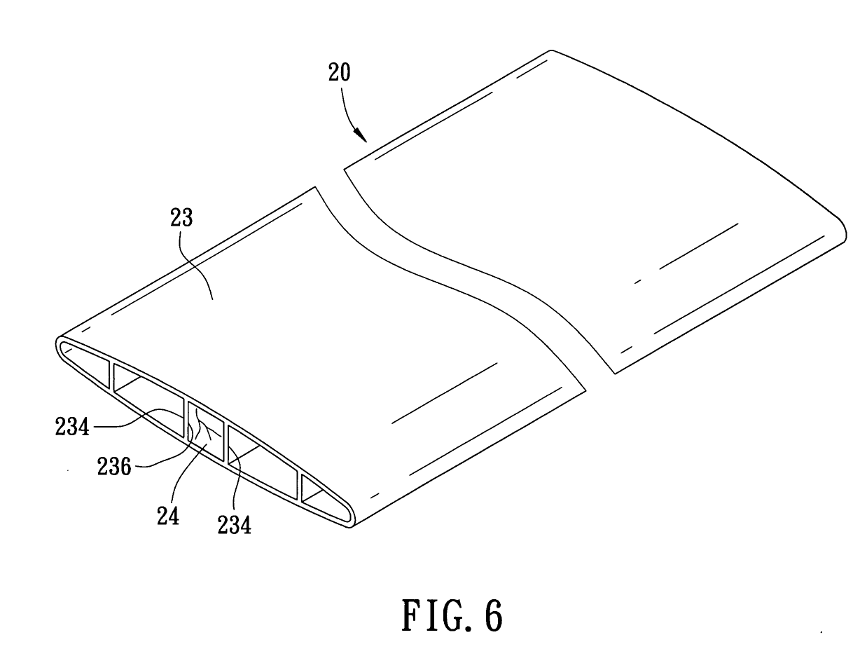

A second preferred embodiment of the blade of a shutter door in the present invention, as shown in FIG. 6, has a structure almost the same as that described in the first preferred embodiment, except that only the hollow space 236 separated by the two reinforcing ribs 234 at the intermediate portion of the blade body 23 is stuffed therein with a solid member 24.

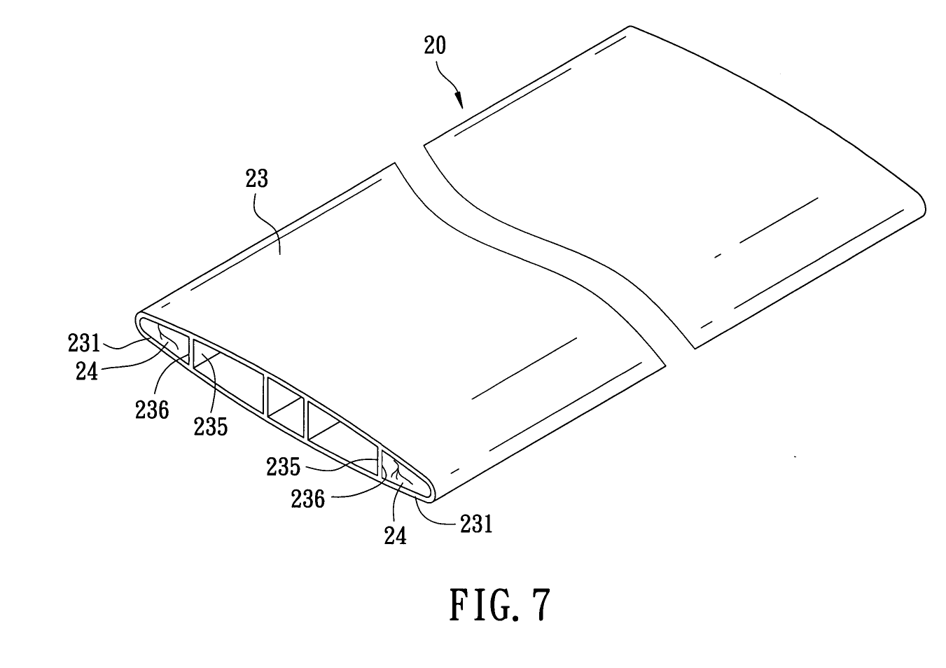

A third preferred embodiment of the blade of a shutter door in the present invention, as shown in FIG. 7, has a structure almost the same as that described in the first preferred embodiment, except that only the two hollow spaces 236 separated by both the two reinforcing ribs 235 near the opposite sides of the blade body 23 and the hollow shell body 23 1 are respectively stuffed therein with a solid member 24.

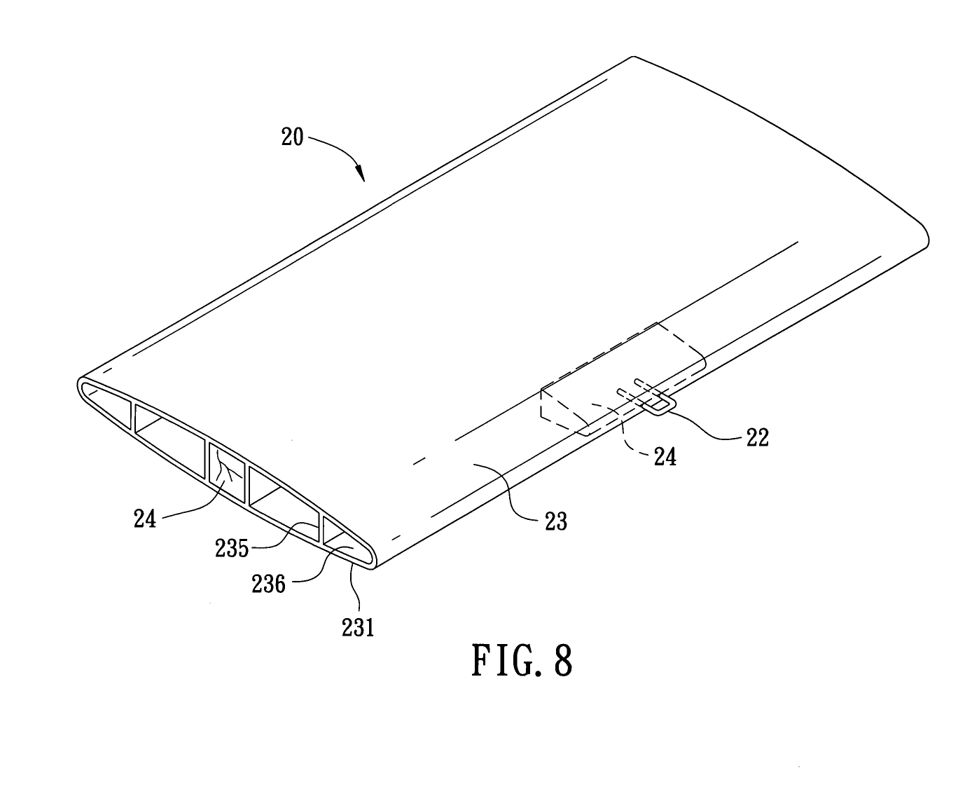

A fourth preferred embodiment of the blade of a shutter door in the present invention, as shown in FIG. 8, has a structure almost the same as that described in the second preferred embodiment, except that the hollow space 236 separated by both the reinforcing rib 235 near one side of the blade body 23 and the hollow shell body 231 is stuffed therein with a length of solid member 24 at an intermediate portion for fixing the U-shaped nail 22 after the U-shaped nail 22 is inserted through the hollow shell 231 of the blade body 23.

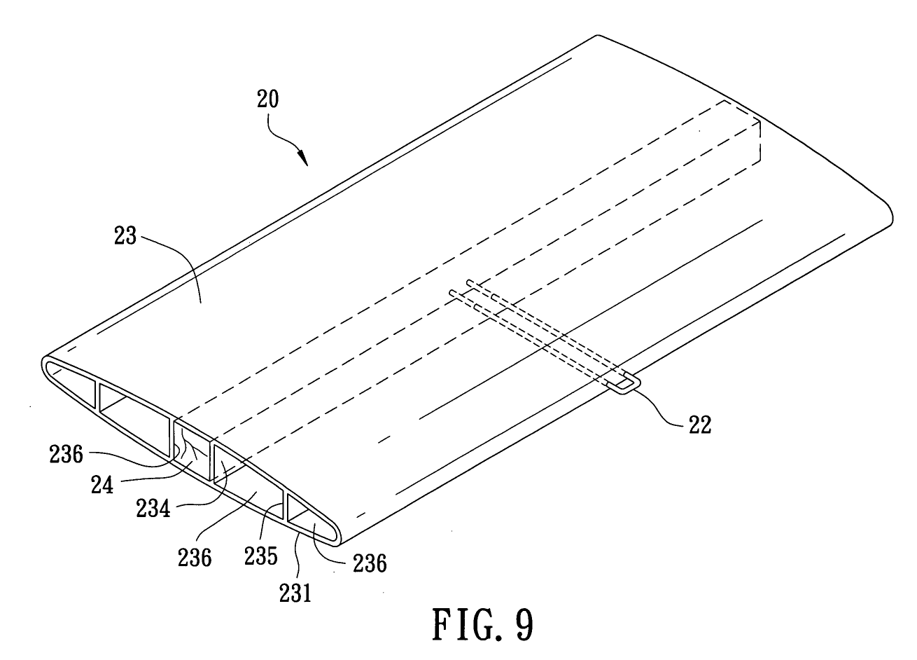

A fifth preferred embodiment of the blade of a shutter door in the present invention, as shown in FIG. 9, has a structure a almost the same as that described in the second preferred embodiment, except that a comparatively long U-shaped nail 22 is inserted through the hollow shell 231 of the blade body 23 and then orderly inserted through one side reinforcing rib 235 and one intermediate reinforcing rib 234 and finally fixed with the solid member 24 stuffed in the intermediate hollow space 236.

As can be understood from the above description, this invention has the following advantages.

1. The blade body 23 is formed integral of plastic with comparatively low specific gravity and shaped as a long and flat hollow body, so the total weight of the blade body 23 is comparatively light, able to lessen the load of the pivot 25 at the opposite ends of the blade 20 and prolong their service life.

2. The blade body 23 is a flat hollow body so it is economical in material cost, conforming to economic gain.

3. The reinforcing ribs 234, 235 properly positioned in the interior of the hollow blade body 23, functioning to strengthen the structure of the blade 20 to prevent the blade 20 from becoming curved and deformed.

4. In accordance with practical needs, the solid member 24 can be optionally stuffed in any one of the five hollow spaces 236 of the blade body 23 for supporting the blade 20 to turn pivotally and fixing the U-shaped nail 22 that connects the blade 20 together with the adjusting rod 30, strengthening the structure of the blade 20.

While the preferred embodiments of the invention have been described above, it will be recognized and understood that various modifications may be made therein and the appended claims are intended to cover all such modifications that may fall within the spirit and scope of the invention.

I claim:

1. The blade of a shutter door comprising:
A blade body shaped as a long and flat hollow shell, said hollow shell formed with a first end and a second end opposite to each other, said hollow shell fixed therein with at least one reinforcing rib between said first and said second end of said hollow shell body, said hollow shell body formed with plural hollow spaces separated by said reinforcing ribs: and
At least one solid member with a preset length stuffed in at least one of said hollow spaces of said blade body.

2. The blade of a shutter door as claimed in claim 1, wherein two reinforcing ribs are fixed at the intermediate portion of said hollow shell between said two ends, and other two reinforcing ribs are respectively disposed at a location near the opposite sides of said blade body, said hollow shell formed with five hollow spaces separated by said four reinforcing ribs.

3. The blade of a shutter door as claimed in claim 2, wherein said hollow space at the intermediate portion of said blade body is stuffed therein with a solid member.

4. The blade of a shutter door as claimed in claim 2, wherein two said hollow spaces at the opposite sides of said blade body are respectively stuffed therein with a solid member.

5. The blade at a shutter door as claimed in claim 2, wherein said hollow spaces at the intermediate portion and at the opposite sides of said blade body are respectively stuffed therein with a solid member.

6. The blade of a shutter door as claimed in claim 1, wherein the length of said solid member is somewhat equivalent to the distance between said two ends of said hollow space.

7. The blade of a shutter door as claimed in claim 1, wherein said solid member is shorter than the distance between said two ends of said hollow space.

8. The blade of a shutter door as claimed in claim 1, wherein said blade body is made of ABS plastics.

9. The blade of a shutter door as claimed in claim 1, wherein said solid member is made of wood.

10. The blade of a shutter door as claimed in claim 1, wherein said solid member has its opposite ends respectively fixed with a pivot.

11. The blade of a shutter door as claimed in claim 1, wherein a U-shaped nail is inserted through said blade body and secured on one side of said solid member.
